(19) United States
(12) Patent Application Publication
(10) Pub. No.: US 2023/0333329 A1
(43) Pub. Date: Oct. 19, 2023

(54) MULTI-FIBER OPTICAL CONNECTOR AND MANUFACTURING METHOD THEREOF

(71) Applicant: NIPPON TELEGRAPH AND TELEPHONE CORPORATION, Tokyo (JP)

(72) Inventors: Yasunari TANAKA, Musashino-shi, Tokyo (JP); Ryo KOYAMA, Musashino-shi, Tokyo (JP)

(73) Assignee: NIPPON TELEGRAPH AND TELEPHONE CORPORATION, Tokyo (JP)

(21) Appl. No.: 18/024,549

(22) PCT Filed: Sep. 11, 2020
(86) PCT No.: PCT/JP2020/034588

§ 371 Date: Mar. 3, 2023

(51) Int. Cl. G02B 6/38

(52) U.S. Cl. CPC G02B 6/3885; G02B 6/3883; G02B 6/3881; G02B 6/3879

(57) ABSTRACT

An object of the present disclosure is to reduce the size and pitch of a multi-core optical connector which connects a planar waveguide in which a multi-channel core is disposed or a plurality of optical fibers to the plurality of optical fibers.

According to the present disclosure, there is provided a multi-core optical connector which connects a plurality of cores disposed in a row and a plurality of optical fibers, in which the multi-core optical connector includes a holding unit which holds the plurality of cores and the plurality of optical fibers, the holding unit includes an elongated hole in which the plurality of optical fibers are disposed in a row, and the plurality of optical fibers and the plurality of cores are connected inside the elongated hole.

### TECHNICAL FIELD

The present invention relates to a multi-core optical connector technology of connecting a planar waveguide in which a plurality of cores are disposed or a plurality of optical fibers to the plurality of optical fibers.

### BACKGROUND ART

In a multi-core optical connector for collectively connecting multi-core optical fibers, circular holes for one optical fiber are conventionally provided in a plurality of rows or pairs of rows in a member called a ferrule, the optical fibers are accommodated in the holes, guide pin holes are provided at both ends of the rows of the holes, and the optical fibers are connected by inserting the guide pins to fit the connectors to each other. Here, positions and sizes of the holes for the optical fibers are made with high accuracy, and gaps between the holes are provided at equal intervals. This structure is, for example, PTL 1.

On the other hand, the optical fibers connected to a transmission device need to be disposed with the pitches of the fibers narrowed in accordance with the miniaturization and space saving of the device as in NPL 1. For example, among connectors having a narrow pitch, there are a connector having a narrow pitch of round holes and a connector formed by aligning fibers on a V-groove as disclosed in PTL 2.

In a multi-core optical connector having round holes as disclosed in PTL 1, when the pitch of the holes is narrowed, the ferrule member between the holes is thinned, which reduces the strength, and the ferrule may be undergo damage such as cracking, and therefore there is a problem that the pitch cannot be narrowed.

In PTL 2, since the position of the fiber changes depending on the shape of the V-groove, there is a risk of adversely affecting the connection loss due to the accuracy of the V-groove. Accordingly, there is a problem that high-precision machining is required to maintain a proper connection loss, resulting in an increase in the cost of the components. For example, although a method of packing at a narrow pitch with the fiber in contact with an elongated hole may be considered, there is a problem that the fiber position is shifted and loss is deteriorated because errors in a fiber outer diameter are accumulated.

### CITATION LIST

### Patent Literature

[PTL 1] Japanese Patent Application Laid-open No. 2000-111759
[PTL 2] Japanese Patent Application Laid-open No. 2007-41044

### Non Patent Literature

[NPL 1] K. Kurata et al., “Prospect of chip scale silicon photonics transceiver for high density multi-mode wiring system,” Optics Communications, Vol. 362, pp. 36-42, 2016.

### SUMMARY OF INVENTION

### Technical Problem

An object of the present disclosure is to reduce the size and pitch of a multi-core optical connector which connects a planar waveguide in which a plurality of cores are disposed or a plurality of optical fibers to the plurality of optical fibers.

### Solution to Problem

In the present disclosure, a plurality of optical fibers are fixed at each of predetermined positions in an elongated hole by a fiber attachment jig. Thus, the present disclosure enables the optical fiber to be fixed without being moved to a bottom surface or a side surface inside the elongated hole.

Specifically, according to the present disclosure, there is provided a multi-core optical connector which connects a plurality of cores disposed in a row and a plurality of optical fibers, the multi-core optical connector including:
a holding unit which holds the plurality of cores and the plurality of optical fibers,
wherein the holding unit includes an elongated hole in which the plurality of optical fibers are disposed in a row, and the plurality of optical fibers and the plurality of cores are connected inside the elongated hole.

Specifically, according to the present disclosure, there is provided a method of manufacturing a multi-core optical connector which connects a plurality of cores disposed in a row and a plurality of optical fibers, wherein the multi-core optical connector includes a holding unit which holds the plurality of cores and the plurality of optical fibers,
the plurality of optical fibers and the planar waveguide are disposed in an elongated hole in which the plurality of optical fibers are disposed in one row in the holding unit, each of the optical fibers protruding from an end surface of the multi-core optical connector is fixed by fiber attachment jigs arranged at intervals of the plurality of cores, and an adhesive is applied to the plurality of optical fibers and the plurality of cores inside the elongated hole and cured, in a state in which the plurality of optical fibers and the plurality of cores are butted against each other inside the elongated hole.

### Advantageous Effects of Invention

According to the present disclosure, it is possible to reduce the size and pitch of a multi-core optical connector which connects a planar waveguide in which a plurality of cores are disposed or a plurality of optical fibers to the plurality of optical fibers.

### BRIEF DESCRIPTION OF DRAWINGS

FIG. 1 shows a schematic configuration of a multi-core optical connector according to the present disclosure.

FIG. 2 is a diagram showing an example of a connection end surface of the multi-core optical connector of the present disclosure.

FIG. 3 shows a method of assembling the connector.

FIG. 4 shows an example of a fiber attachment jig.

FIG. 5 is a diagram showing an example of a method of deforming and disposing an optical fiber in a row.

FIG. 6 is a view showing an example of the connection end surface of the multi-core optical connector of the present disclosure.

FIG. 7 shows a method of assembling using a jig when an alignment structure is a multi-stage.

FIG. 8 shows an example of the fiber attachment jig.

FIG. 9 shows an alignment method using a guide pin and a guide pin hole in the alignment structure.

FIG. 10 shows an example of a structure of a ferrule connection surface.

FIG. 11 shows an alignment method using a guide pin and a V-groove.

FIG. 12 shows an example of the structure of the ferrule connection surface.

FIG. 13 shows an alignment method using a sleeve provided with a hole of substantially the same inner shape as a connector outer shape.

FIG. 14 shows a top view of a connector after connection of an optical fiber 91.

### DESCRIPTION OF EMBODIMENTS

An embodiment of the present disclosure will be described in detail below with reference to the drawings. The present disclosure is not limited to the embodiment described below. The embodiment is merely illustrative, and the present disclosure can be implemented with a variety of modifications and improvements made thereto on the basis of the knowledge of a person skilled in the art. Note that the elements designated by the same reference numerals in the description and the drawings refer to the same elements.

The present disclosure provides a multi-core optical connector having a higher density and an axis alignment mechanism, in which one elongated hole having a flat bottom surface is formed, and a fiber is disposed at a predetermined position by a jig outside the connector. Thus, in the present disclosure, since the pitch of the fiber is narrowed down to a pitch on a waveguide side, a ferrule member having a structure independent of the number of cores can be provided, and the alignment of each fiber is independent, thereby suppressing the connection loss.

### First Embodiment

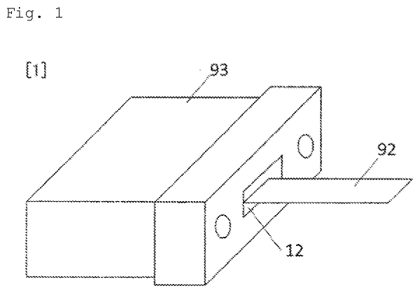

Hereinafter, a multi-core optical connector according to the present disclosure will be described with reference to the drawings. FIG. 1 shows a schematic configuration of a multi-core optical connector according to the present disclosure. A multi-core optical connector 93 according to the present disclosure is a multi-core optical connector which connects a planar waveguide 92 and a plurality of optical fibers 91. The planar waveguide 92 is an optical component in which a multichannel core is disposed, and may be a plurality of optical fibers. An example in which an optical component having the multi-channel core disposed therein is the planar waveguide 92 will be described below.

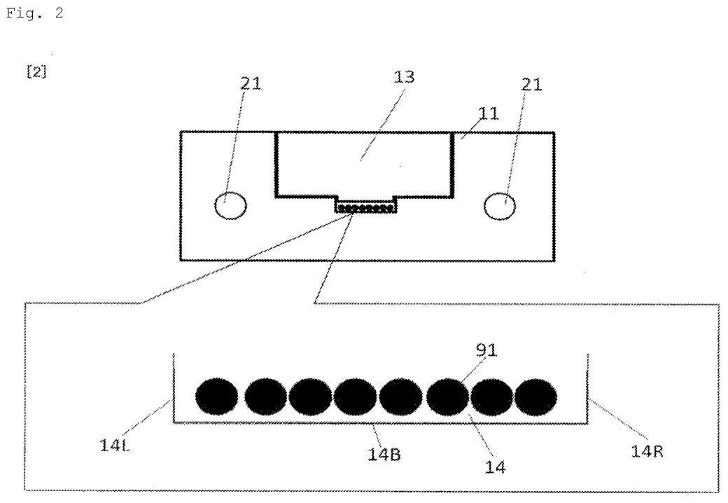

FIG. 2 shows a structure in which a hole 12 is provided using a groove 14 and a lid 13. A plurality of (eight in the drawing) optical fibers 91 are inserted into the groove 14, the lid 13 is inserted into the groove 14 while an adhesive is inserted, for example, from above, and the adhesive is fixed while being pressed from above. Accordingly, the lid 13 and the optical fiber 91 can be fixed.

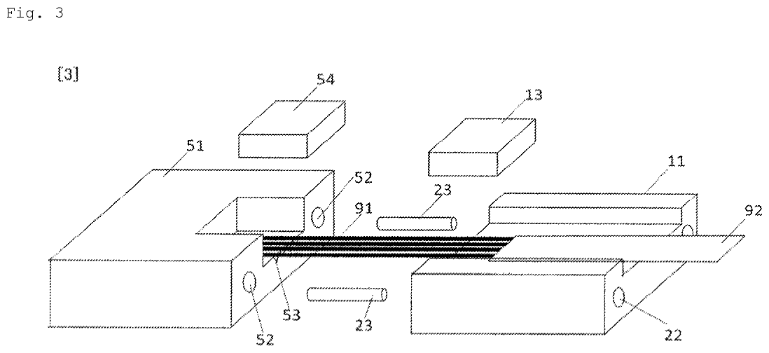

FIG. 3 shows a method of assembling the multi-core optical connector of the present disclosure. In this example, a fiber attachment jig 51 is used. The fiber attachment jig 51 has a structure for disposing and holding the optical fibers 91 at predetermined positions at equal intervals.

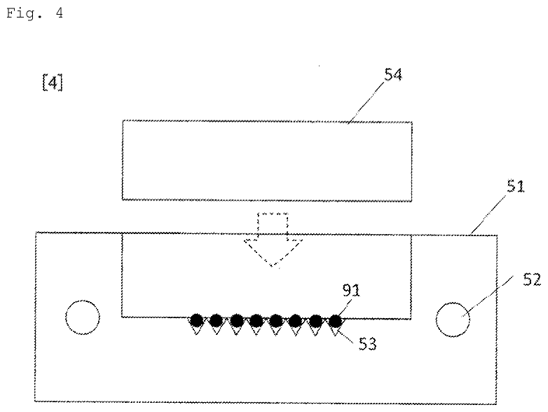

FIG. 4 shows an example of the fiber attachment jig 51. The predetermined position is a position that corresponds to the waveguide core of the planar waveguide 92. For example, the fiber attachment jig 51 includes a V-groove 53 disposed at a position of the waveguide core of the planar waveguide 92, and a lid 54 for pressing the optical fiber 91 disposed in the V-groove 53.

The fiber attachment jig 51 and the ferrule 11 are aligned, the adhesive and the plurality of (eight in the drawing) optical fibers 91 are inserted into the elongated hole 12 in the ferrule 11, the optical fibers 91 protruding from the connector end surface including the ferrule 11 are held by the fiber attachment jig 51 and the lid 54, and the optical fibers 91 are fixed at a desired position.

By aligning the V-groove 53 of the fiber attachment jig 51 and the waveguide core of the planar waveguide 92 of the ferrule 11, the optical fiber 91 held by the ferrule 11 can be aligned with the position of the waveguide core of the planar waveguide 92. The alignment may be performed by making the guide pin 23 pass through the guide pin holes 22 and 52.

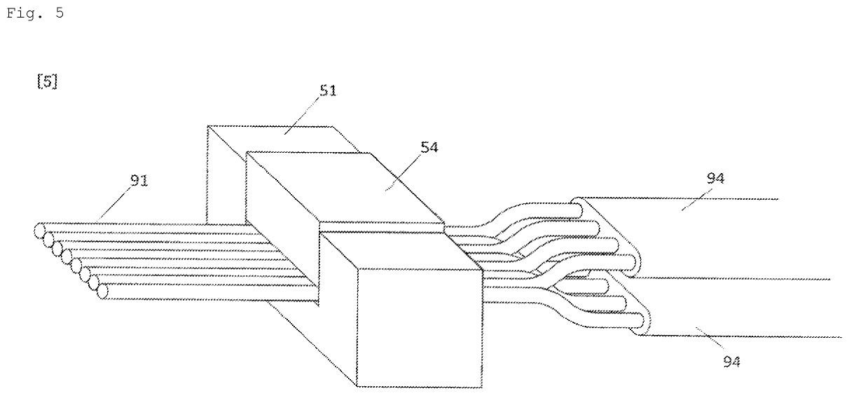

No particular method of deforming and disposing the optical fibers 91 is designated, but as shown in FIG. 5, for example, tape core wires passing through the respective stages are crossed up and down, using two tape core wires 94, and the optical fibers 91 are gripped and fixed by the fiber attachment jig 51 and the lid 54.

### Second Embodiment

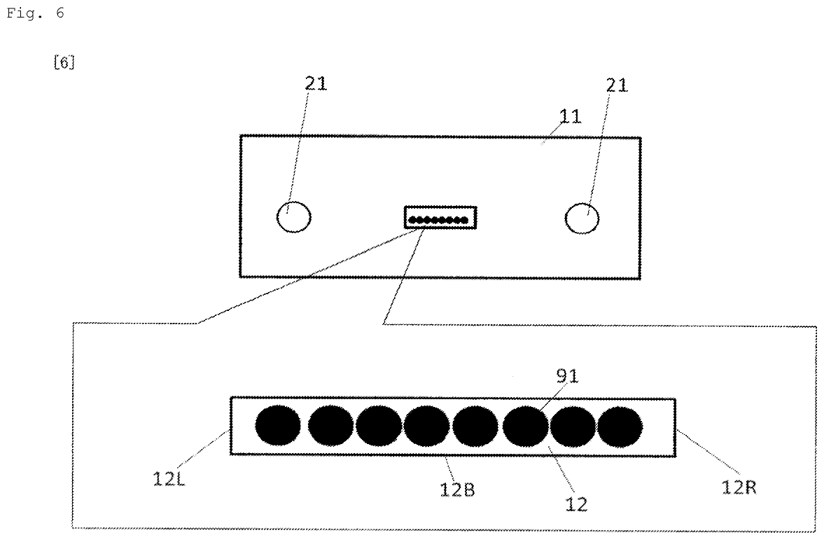

FIG. 6 is a diagram showing an example of a connection end surface of the multi-core optical connector of the present disclosure. A plurality of (eight in the drawing) optical fibers 91 are disposed at predetermined positions at equal intervals by the fiber attachment jig inside the ferrule 11 having the rectangular elongated hole 12, and are not in contact with an inner wall of the elongated hole 12. The elongated hole 12 inside the ferrule 11 may be formed so that the optical fibers 91 can be disposed at a predetermined position, and though the size and shape of the hole are not particularly limited, the hole may be formed to be sufficiently large or may not have a rectangular shape with respect to the number of cores. Further, the alignment structure 21 is provided on the right and left outer sides of the elongated hole 12 on the end surface of the ferrule 11.

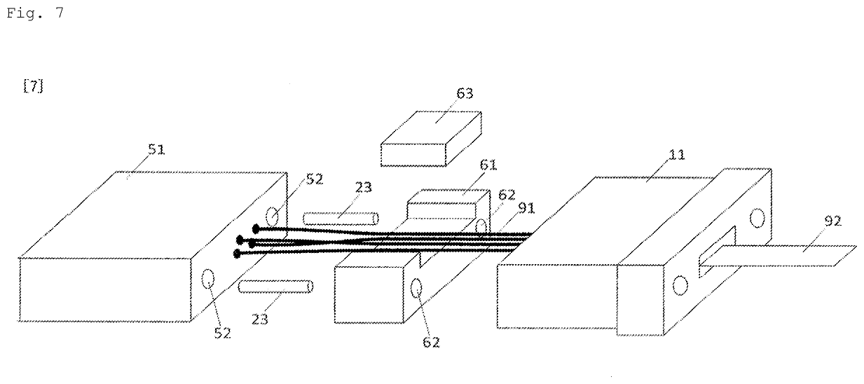

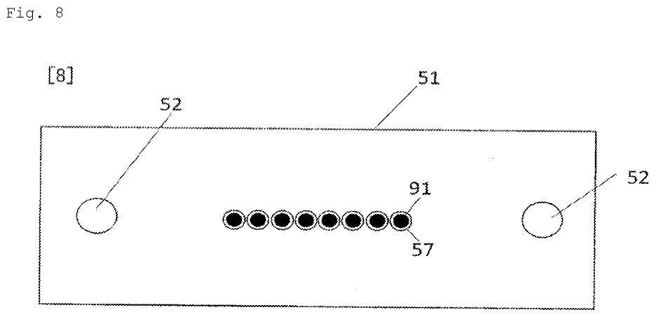

FIG. 7 shows a method of assembling using a jig when the alignment structure is a multi-stage. In this example, the fiber attachment jig 51 and the jig 61 are used. FIG. 8 shows an example of the fiber attachment jig 51. The fiber attachment jig 51 is provided with holes 57 for disposing the optical fibers 91 at equal intervals. In the present embodiment, the optical fibers 91 are disposed at regular intervals and held at predetermined positions, using the fiber attachment jig 51, the optical fibers 91 are sandwiched and pressed between the fiber attachment jig 51 and the ferrule 11 by the jig 61 and the lid 63, and the optical fibers are fixed in a row. Accordingly, the optical fibers 91 can be disposed in one row on the connector end surface including the ferrule 11.

### Third Embodiment

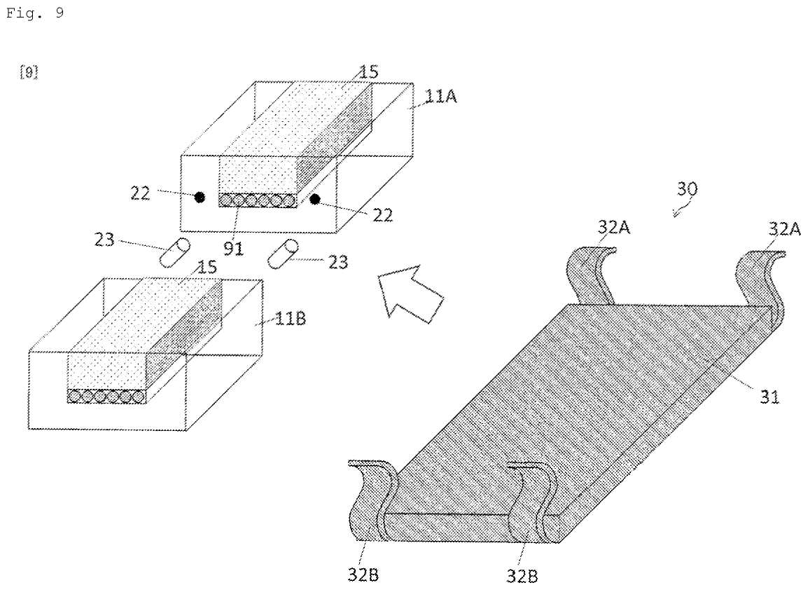

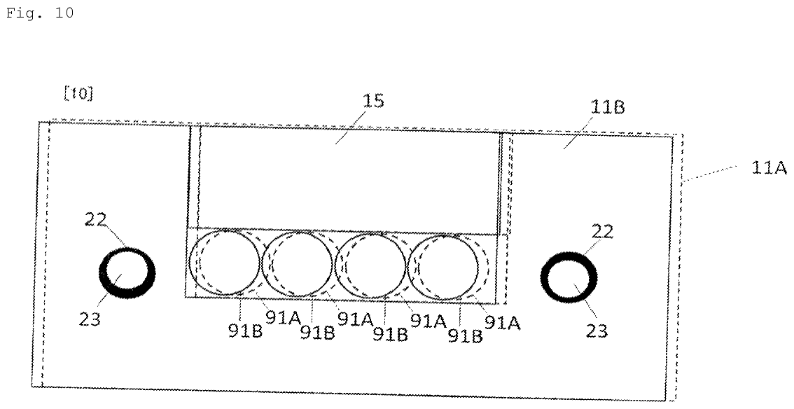

FIG. 9 shows an alignment method using the guide pin 23 and the guide pin hole 22 in the alignment structure 21. Ferrules 11A and 11B provided with guide pin holes 22 at both ends of the elongated hole are opposed to each other, a guide pin 23 is used for aligning the ferrules 11A and 11B, the ferrules 11A and 11B pass through the guide pin holes 22, and the ferrules 11A and 11B are fixed by a connecting clip 30. Thus, as shown in FIG. 10, an optical fiber 91A fixed to the elongated hole of the ferrule 11A and an optical fiber 91B fixed to the elongated hole of the ferrule 11B are connected.

### Fourth Embodiment

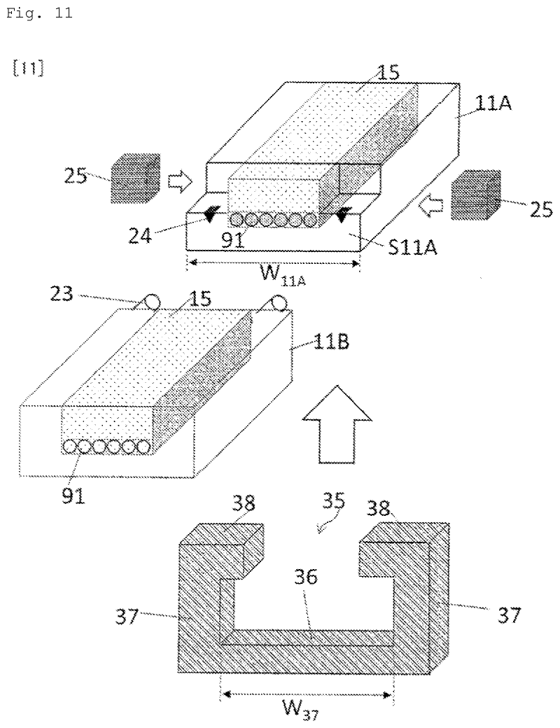

FIG. 11 shows an alignment method using the guide pin and the V-groove in the alignment structure 21. In this embodiment, the ferrule 11B provided with the guide pin 23 and the ferrule 11A provided with the V-groove 24 are used. In a state in which the guide pin 23 is placed on the V-groove 24, the block 25 is placed on the guide pin 23, and pressed from above the block 25 by a pressing clip 35.

The pressing clip 35 presses the block 25 along a notch of the ferrule 11A, and the guide pin 23 is fixed to the V-groove 24. As a result, the present embodiment can connect the optical fibers 91 while aligning the optical fibers 91.

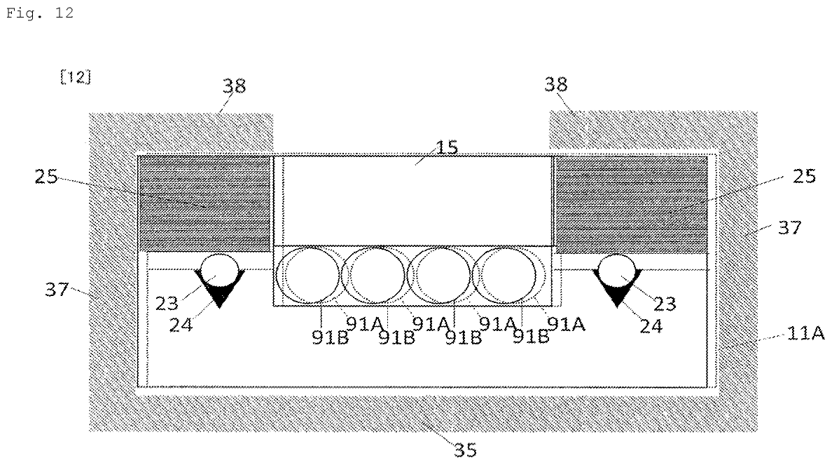

FIG. 12 shows an example of the structure of the ferrule connection surface. The pressing clip 35 can adopt an arbitrary structure capable of pressing the guide pin 23 to the V-groove 24. For example, an L-shaped claw 37 for pressing the top of the block 25 can be provided on the base plate 31. An interval W37 of the claws 37 is equal to a lateral width W11A of the ferrule 11A. A tip 38 of the claw 37 may reach the V groove 24 and have a sufficient length to cover the block 25. The present embodiment may further include a connecting clip 30.

### Fifth Embodiment

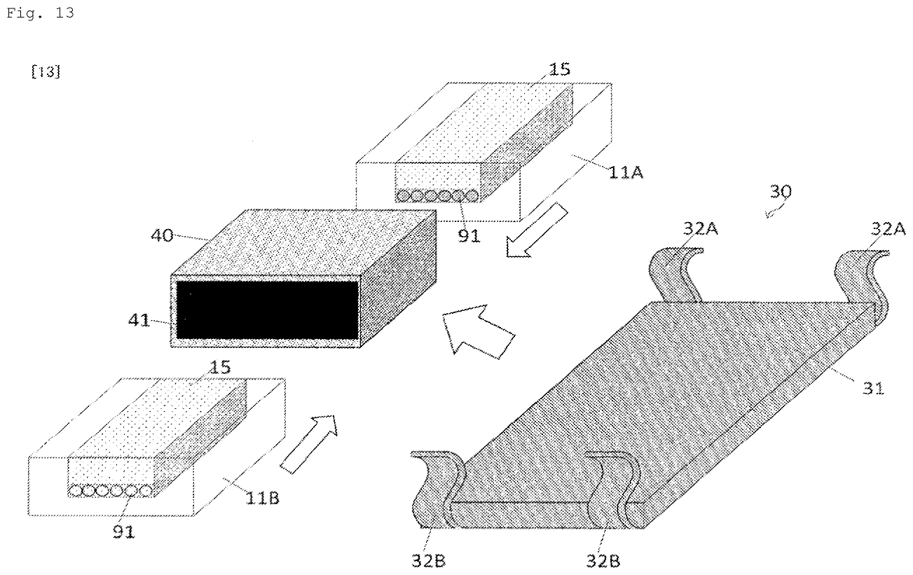

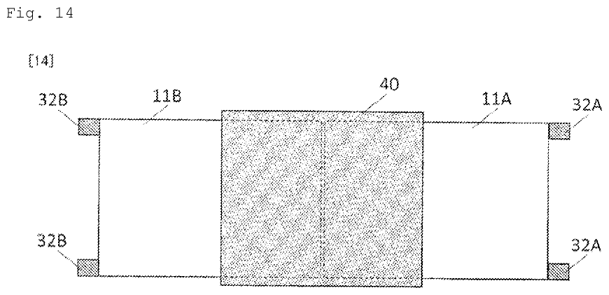

FIG. 13 shows an alignment method using a sleeve 40 provided with a hole having an inner shape substantially the same as the outer shapes of the ferrules 11A and 11B. FIG. 14 shows a top view of the connector after the optical fibers 91 are connected. In this embodiment, the ferrules 11A and 11B are inserted from both ends of the sleeve 40, and are fixed by the connecting clip 30 or the like so that they do not fall off. Accordingly, alignment is performed inside the sleeve 40. As a result, the present embodiment can connect the optical fibers 91 while aligning the optical fibers 91.

Although the numbers of optical fibers 91 shown in the above-described embodiments are eight and four, the number of optical fibers is not specifically defined.

Although the structures for holding the fiber are V grooves and round holes in FIGS. 3 and 7, this is not a specific definition, and they may be square holes or grooves having a multi-stage structure, for example.

Although the ferrule has a structure of a groove and a lid and a structure of an elongated hole in FIGS. 3 and 7, respectively, the correspondence between the ferrule and the opposing fiber attachment jig is not specifically defined. There is no specific definition of the method of connection, and instead of the connecting clip shown in FIGS. 9 to 14, a spring force may be applied from the rear side, for example, using a housing member.

The present disclosure provides an optical connector which incorporates the optical fibers 91 and connects them to the end surface of the waveguide in an abutted state to collectively connect the planar waveguide 92 in which a plurality of multichannel cores are disposed equally on the right and left sides and the plurality of optical fibers 91, and has, as shown in FIG. 6, a structure which includes the elongated hole 12 in which a plurality of optical fibers are laid, and the optical fibers 91 accommodated and fixed in a row inside the elongated hole 12. In the present disclosure, the planar waveguide 92 may be a plurality of optical fibers.

In addition, the present disclosure provides an optical connector which incorporates the optical fibers 91 and connects them to the end surface of the waveguide in an abutted state to collectively connect the planar waveguide 92 in which a plurality of multichannel cores are disposed equally on the right and left sides and the plurality of optical fibers, and has, as shown in FIG. 2, a structure which includes the elongated hole 12 in which a plurality of optical fibers 91 are laid, and the optical fibers 91 accommodated and fixed in a row inside the elongated hole 12, in which the elongated hole 12 includes the groove 14 and the lid 13, and the lid 13 is fixed.

In addition, the present disclosure has a structure in which the optical fibers 91 are disposed at predetermined positions at equal intervals on an end surface of the multi-core optical connector, and at least one or more sets of fibers are not in contact with each other on the end surface of the multi-core optical connector.

The multi-core optical connector of the present disclosure also has a structure in which at least one core of the optical fiber is positioned on the end surface of the connector without coming into contact with an inner wall of the elongated hole.

The multi-core optical connector of the present disclosure also has a structure in which at least one core of the optical fiber is not in contact with right and left inner walls on the end surface of the connector, and at least one core is positioned to come into contact with a wall on a bottom surface or an upper surface.

The multi-core optical connector of the present disclosure also has a structure in which an alignment structure is constituted by guide pin holes provided at both ends of the elongated hole, and the alignment is performed by fitting the guide pins and the guide pin holes, using guide pins for aligning the planar waveguide or the connectors.

The multi-core optical connector of the present disclosure also has a structure in which the alignment structure is constituted by guide pin holes and V-grooves provided at both ends of the elongated hole, and alignment is performed by attaching the guide pins to the guide pin holes, pressing the guide pins against the V-grooves, and pressing the guide pins and the V-grooves from above to fix the guide pins, using the guide pins for aligning the planar waveguide or connectors.

The multi-core optical connector of the present disclosure also has a structure in which the alignment is performed by butting the connectors from the right and left sides inside a sleeve, using the sleeve provided with a through hole that has an inner shape in which an alignment structure is substantially the same as an outer shape of the connector.

The present disclosure also provides, as a method of assembling a multi-core optical connector, a fiber assembly method in which the fiber protruding from a connector end surface is gripped by a fiber attachment jig having a structure which performs alignment with a connector facing a structure in which optical fibers are disposed and gripped at regular intervals at a predetermined position, and the fiber is fixed at a predetermined position by applying an adhesive and curing the adhesive.

The present disclosure also provides a method of assembling a multi-core optical connector, in which a structure in which optical fibers are disposed and gripped at predetermined positions of a fiber attachment jig at equal intervals in a lateral direction is a round hole.

The present disclosure also provides a method of assembling a multi-core optical connector, in which a structure in which optical fibers are disposed and gripped at regular intervals at predetermined positions of the fiber attachment jig is a groove and a lid.

The present disclosure also provides a method of assembling a multi-core optical connector, in which a structure and a method of disposing and gripping the optical fibers at predetermined positions of the fiber attachment jig at equal intervals are constituted of multiple stages or a plurality of jigs, and the fibers are deformed and the fibers are aligned in one row on the end surface of the connector.

### Effects of Present Disclosure

Since there is no ferrule member between the optical fibers when the pitch of the optical fibers is narrowed, the problem of damage caused by the thinning of the member is solved, and the pitch of the optical fibers can be narrowed down to the fiber diameter.

Thus, miniaturization and narrow pitch can be attained, and connection with a smaller module can be attained.

Since the ferrule having a structure independent of the number of cores can be molded, the same ferrule can be used in manufacturing.

The problem that the position of the optical fiber is shifted with an increase in the number of cores is solved, and the connector with excellent connection loss can be produced.

### INDUSTRIAL APPLICABILITY

The present disclosure is applicable to the information communication industry.

### REFERENCE SIGNS LIST

11 Ferrule
12 Elongated hole
13 Plate
14 Groove
15 Lid
16 Elastic body
21 Alignment structure
22, 52 Guide pin hole
23 Guide pin
24 V-groove
25 Block
30 Connection clip
31 Base plate
32A, 32B Spring
37 Claw
35 Pressing clip
40 Sleeve
41 Through hole
51 Fiber attachment jig
53 V-groove
54 Lid
54 Groove
57 Hole
91 Optical fiber
92 Optical waveguide
93 Multi-core optical connector
94 Tape core wire

1. A multi-core optical connector which connects a plurality of cores disposed in a row and a plurality of optical fibers, the multi-core optical connector comprising:
a holding unit which holds the plurality of cores and the plurality of optical fibers,
wherein the holding unit includes an elongated hole in which the plurality of optical fibers are disposed in a row, and
the plurality of optical fibers and the plurality of cores are connected inside the elongated hole.

2. The multi-core optical connector according to claim 1, wherein
the plurality of cores are disposed at equal intervals, and
the plurality of optical fibers are disposed at the same intervals as the plurality of cores in a state in which the plurality of optical fibers are not in contact with an inner wall of the elongated hole or an adjacent optical fiber.

3. The multi-core optical connector according to claim 1, wherein the plurality of cores are cores provided in the plurality of optical fibers or planar waveguides.

4. The multi-core optical connector according to claim 1, wherein the elongated hole is formed by
a groove which is provided in the holding unit to dispose the plurality of cores and the plurality of optical fibers; and
a lid which is disposed on the plurality of cores and the plurality of optical fibers disposed in the groove.

5. A method of manufacturing a multi-core optical connector which connects a plurality of cores disposed in a row and a plurality of optical fibers, wherein
the multi-core optical connector includes a holding unit which holds the plurality of cores and the plurality of optical fibers,
the plurality of optical fibers and the planar waveguide are disposed in an elongated hole in which the plurality of optical fibers are disposed in one row in the holding unit,
each of the optical fibers protruding from an end surface of the multi-core optical connector is fixed by fiber attachment jigs arranged at intervals of the plurality of cores, and
an adhesive is applied to the plurality of optical fibers and the plurality of cores inside the elongated hole and cured, in a state in which the plurality of optical fibers and the plurality of cores are butted against each other inside the elongated hole.
